(19) United States
(12) Patent Application Publication
(10) Pub. No.: US 2022/0364639 A1
(43) Pub. Date: Nov. 17, 2022

(54) DRIVE ASSEMBLY

(71) Applicant: Stolle Machinery Company, LLC, Centennial, CO (US)

(72) Inventors: Ian Kenneth Scholey, Barnsley (GB); Joseph John Allen Maurer, Aurora, CO (US); Stephen Dane Christensen, Highlands Ranch, CO (US)

(73) Assignee: Stolle Machinery Company, LLC, Centennial, CO (US)

(21) Appl. No.: 17/319,689

(22) Filed: May 13, 2021

(51) Int. Cl. F16H 57/033; B21D 51/26

(52) U.S. Cl. CPC F16H 57/033; B21D 51/2638; B21D 51/2692; F16H 2057/0335

(57) ABSTRACT

A distributed drive assembly for a necker machine having a frame assembly and a plurality of modules, each module having a number of drive shafts, the number of drive shafts of each module interconnected via a gear train with the number of drive shafts of the other modules of the plurality of processing modules. The distributed drive assembly includes: a plurality of drive sub-modules, each drive sub-module having: an input shaft; a first output shaft operatively coupled to the input shaft; and a second output shaft operatively coupled to the input shaft. For a first drive sub-module: the input shaft is structured to be operatively coupled to, and driven by, a main drive assembly motor, and the first output shaft is structured to be operatively coupled to, and drive, an associated first drive shaft of the number of drive shafts of a first module of the plurality of modules. For a second drive sub-module: the input shaft is operatively coupled to, and driven by, the second output shaft of the first drive sub-module, and the first output shaft is structured to be operatively coupled to, and drive, an associated first drive shaft of the number of drive shafts of a second module of the plurality of modules that is separated from the first module by at least one other module.

### BACKGROUND OF THE INVENTION

### Field of the Invention

The disclosed and claimed concepts relate to drive assemblies and, more particularly, to drive assemblies for necker machines.

### Background Information

Can bodies are, typically, formed in a bodymaker. That is, a bodymaker forms blanks such as, but not limited to, disks or cups into an elongated can body. A can body includes a base and a depending sidewall. The sidewall is open at the end opposite the base. The bodymaker, typically, includes a ram/punch that moves the blanks through a number of dies to form the can body. The can body is ejected from the ram/punch for further processing such as, but not limited to, trimming, washing, printing, flanging, and inspecting, before being placed on pallets which are then shipped to a filler. At the filler, the cans are taken off of the pallets, filled, have ends placed on them, and then are typically repackaged in various quantities (e.g., six packs, twelve pack or other multi-can cases, etc.) for sale to the consumer.

Some can bodies after being formed in a bodymaker are further formed in a die necking machine, commonly referred to as simply a necker machine. Necker machines are structured to reduce the cross-sectional area of a portion of a can body sidewall, i.e., at the open end of the sidewall. That is, prior to coupling a can end to the can body (and prior to filling), the diameter/radius of the can body sidewall open end is reduced relative to the diameter/radius of other portions of the can body sidewall. The necker machine includes a number of processing and/or forming modules disposed in series. That is, the processing and/or forming modules are disposed adjacent to each other and a transfer assembly moves a can body between adjacent processing and/or forming modules. As the can body moves through the processing and/or forming modules the can body is processed or formed. A greater number of processing and/or forming modules in a necker machine is not desirable. That is, it is desirable to have the least number of processing and/or forming modules possible while still completing the desired forming.

Some die necking machine configurations require a large number of necking modules. The rotational position of each module must be kept in sync with adjacent modules, which is typically accomplished through the use of a gear train that effectively connects/drives all of the other modules. Such gear train is typically driven only at one end. The gear tooth load at the aforementioned driven end of the gear train is very high, whereas load on the opposite end of the gear train is low. This results in uneven gear wear along the gear train and requires the majority of gears in the train to be oversized which incurs additional and unnecessary expense.

### SUMMARY OF THE INVENTION

Embodiments of the disclosed concepts provide solutions that spread the induced loads and wear more evenly throughout the gear train, thus improving upon known arrangements. As one aspect of the disclosed concepts, a distributed drive assembly for a necker machine having a frame assembly and a plurality of modules is provided. Each module having a number of drive shafts, with the number of drive shafts of each module interconnected via a gear train with the number of drive shafts of the other modules of the plurality of processing modules. The distributed drive assembly comprises: a plurality of drive sub-modules, each drive sub-module comprising: an input shaft; a first output shaft operatively coupled to the input shaft; and a second output shaft operatively coupled to the input shaft; wherein for a first drive sub-module of the plurality of drive sub-modules: the input shaft is structured to be operatively coupled to, and driven by, a main drive assembly motor, and the first output shaft is structured to be operatively coupled to, and drive, an associated first drive shaft of the number of drive shafts of a first module of the plurality of modules, and wherein for a second drive sub-module of the plurality of drive sub-modules: the input shaft is operatively coupled to, and driven by, the second output shaft of the first drive sub-module, and the first output shaft is structured to be operatively coupled to, and drive, an associated first drive shaft of the number of drive shafts of a second module of the plurality of modules that is separated from the first module by at least one other module.

The distributed drive assembly may further comprise an extension shaft, wherein the input shaft of the second drive sub-module is operatively coupled to the second output shaft of the first drive sub-module by the extension shaft. The extension shaft may be sized and configured to space the first output shaft of the second drive sub-module a distance from the first output shaft of the first drive sub-module, and wherein the distance is greater than an overall width of one module of the plurality of processing modules.

The plurality of drive modules may comprise at least three drive sub-modules, and for a third drive sub-module of the plurality of drive sub-modules: the input shaft may be operatively coupled to, and driven by, the second output shaft of the second drive sub-module, and the first output shaft may be structured to be operatively coupled to, and drive, one drive shaft of the number of drive shafts of a third module of the number of modules.

For each drive sub-module, the first output shaft may be operatively coupled to the input shaft via a right-angle gearbox.

For each drive sub-module, the second output shaft may be axially aligned with the input shaft.

The distributed drive assembly may further comprise the main drive assembly motor coupled to the input shaft of the first drive sub-module of the plurality of drive sub-modules.

The distributed drive assembly may further comprise at least two extension shafts, wherein the input shaft of the second drive sub-module is operatively coupled to the second output shaft of the first drive sub-module by the at least two extension shafts connected together in series.

The distributed drive assembly may further comprise a winding arrangement operatively coupled to the second output shaft of the second drive sub-module.

As another aspect of the disclosed concepts a necker machine comprises: a frame assembly; a plurality of modules coupled to the frame assembly, each module having a number of drive shafts, and a drive assembly comprising: a gear train comprising a plurality of gears, each gear coupled to a respective drive shaft of the number of drive shafts of the plurality of modules and interconnecting the number of drive shafts of each module with the number of drive shafts of the other modules of the plurality of modules; and a distributed drive assembly comprising a plurality of drive sub-modules, each drive sub-module comprising: an input shaft; a first output shaft operatively coupled to the input shaft; and a second output shaft operatively coupled to the input shaft; wherein for a first drive sub-module of the plurality of drive sub-modules: the input shaft is structured to be operatively coupled to, and driven by, a main drive assembly motor, and the first output shaft is operatively coupled to, for driving, an associated first drive shaft of the number of drive shafts of a first module of the plurality of modules, and wherein for a second drive sub-module of the plurality of drive sub-modules: the input shaft is operatively coupled to, and driven by, the second output shaft of the first drive sub-module, and the first output shaft is operatively coupled to, for driving, an associated first drive shaft of the number of drive shafts of a second module of the plurality of modules that is separated from the first module by at least one other module.

The necker machine may further comprise the main drive assembly motor coupled to the input shaft of the first drive sub-module of the plurality of drive sub-modules.

The first output shaft of the first drive sub-module may be coupled to the associated first drive shaft of the number of drive shafts of the first module via a speed reducing gearbox and a drive hub, and the first output shaft of the second drive sub-module may be coupled to the associated first drive shaft of the number of drive shafts of the second module via another speed reducing gearbox and another drive hub.

The necker machine may further comprise an extension shaft, wherein the input shaft of the second drive sub-module is operatively coupled to the second output shaft of the first drive sub-module by the extension shaft. The extension shaft may be sized and configured to space the first output shaft of the second drive sub-module a distance from the first output shaft of the first drive sub-module, and wherein the distance is greater than an overall width of one module of the plurality of processing modules.

The plurality of drive modules may comprise at least three drive sub-modules, and wherein for a third drive sub-module of the plurality of drive sub-modules: the input shaft is operatively coupled to, and driven by, the second output shaft of the second drive sub-module, and the first output shaft is operatively coupled to, and drives, one drive shaft of the number of drive shafts of a third module of the number of modules.

For each drive sub-module, the first output shaft may be operatively coupled to the input shaft via a right-angle gearbox.

For each drive sub-module, the second output shaft may be axially aligned with the input shaft.

The necker machine may further comprise at least two extension shafts, wherein the input shaft of the second drive sub-module is operatively coupled to the second output shaft of the first drive sub-module by the at least two extension shafts connected together in series.

The necker machine may further comprise a winding arrangement operatively coupled to the second output shaft of the second drive sub-module.

These and other objects, features, and characteristics of the disclosed concepts, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed concepts.

### BRIEF DESCRIPTION OF THE DRAWINGS

A full understanding of the disclosed concepts can be gained from the following description of some example embodiments when read in conjunction with the accompanying drawings in which:

FIG. 1 is a perspective view of the processing side of a necker machine in accordance with an exemplary embodiment of the disclosed concept.

FIG. 2 is another perspective view of the processing side of the necker machine of FIG. 1.

FIG. 3 is an elevation view of the processing side of the necker machine of FIGS. 1 and 2.

FIG. 4 is a partially schematic elevation view of the drive side of the necker machine of FIGS. 1-3.

FIG. 5 is a schematic cross-sectional view of a can body.

FIG. 6 is a partially schematic perspective view of the drive side of a necker machine in accordance with another exemplary embodiment of the disclosed concept.

FIGS. 7 and 8 are detail views of portions of a distributed drive assembly of the necker machine of FIG. 6.

FIG. 9 is a partially schematic perspective view of the drive side of a necker machine in accordance with yet another exemplary embodiment of the disclosed concept.

It is to be appreciated that portions of the figures not pertinent to the portions being discussed may be shown in simplified form or omitted therefrom.

### DESCRIPTION OF THE PREFERRED EMBODIMENTS

It will be appreciated that the specific elements illustrated in the figures herein and described in the following specification are simply exemplary embodiments of the disclosed concept, which are provided as non-limiting examples solely for the purpose of illustration. Therefore, specific dimensions, orientations, assembly, quantity of components used, embodiment configurations and other physical characteristics related to the embodiments disclosed herein are not to be considered limiting on the scope of the disclosed concept.

Directional phrases used herein, such as, for example, clockwise, counterclockwise, left, right, top, bottom, upwards, downwards and derivatives thereof, relate to the orientation of the elements shown in the drawings and are not limiting upon the claims unless expressly recited therein.

As used herein, the singular form of “a”, “an”, and “the” include plural references unless the context clearly dictates otherwise.

As used herein, “structured to [verb]” means that the identified element or assembly has a structure that is shaped, sized, disposed, coupled and/or configured to perform the identified verb. For example, a member that is “structured to move” is movably coupled to another element and includes elements that cause the member to move or the member is otherwise configured to move in response to other elements or assemblies. As such, as used herein, “structured to [verb]” recites structure and not function. Further, as used herein, “structured to [verb]” means that the identified element or assembly is intended to, and is designed to, perform the identified verb. Thus, an element that is merely capable of performing the identified verb but which is not intended to, and is not designed to, perform the identified verb is not “structured to [verb].”

As used herein, “associated” means that the elements are part of the same assembly and/or operate together, or, act upon/with each other in some manner. For example, an automobile has four tires and four hub caps. While all the elements are coupled as part of the automobile, it is understood that each hubcap is “associated” with a specific tire.

As used herein, a “coupling assembly” includes two or more couplings or coupling components. The components of a coupling or coupling assembly are generally not part of the same element or other component. As such, the components of a “coupling assembly” may not be described at the same time in the following description.

As used herein, a “coupling” or “coupling component(s)” is one or more component(s) of a coupling assembly. That is, a coupling assembly includes at least two components that are structured to be coupled together. It is understood that the components of a coupling assembly are compatible with each other. For example, in a coupling assembly, if one coupling component is a snap socket, the other coupling component is a snap plug, or, if one coupling component is a bolt, then the other coupling component is a nut or threaded bore. Further, a passage in an element is part of the “coupling” or “coupling component(s).” For example, in an assembly of two wooden boards coupled together by a nut and a bolt extending through passages in both boards, the nut, the bolt and the two passages are each a “coupling” or “coupling component.”

As used herein, a “fastener” is a separate component structured to couple two or more elements. Thus, for example, a bolt is a “fastener” but a tongue-and-groove coupling is not a “fastener.” That is, the tongue-and-groove elements are part of the elements being coupled and are not a separate component.

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are coupled in direct contact with each other. As used herein, “fixedly coupled” or “fixed” means that two components are coupled so as to move as one while maintaining a constant orientation relative to each other. As used herein, “adjustably fixed” means that two components are coupled so as to move as one while maintaining a constant general orientation or position relative to each other while being able to move in a limited range or about a single axis. For example, a doorknob is “adjustably fixed” to a door in that the doorknob is rotatable, but generally the doorknob remains in a single position relative to the door. Further, a cartridge (nib and ink reservoir) in a retractable pen is “adjustably fixed” relative to the housing in that the cartridge moves between a retracted and extended position, but generally maintains its orientation relative to the housing. Accordingly, when two elements are coupled, all portions of those elements are coupled. A description, however, of a specific portion of a first element being coupled to a second element, e.g., an axle first end being coupled to a first wheel, means that the specific portion of the first element is disposed closer to the second element than the other portions thereof. Further, an object resting on another object held in place only by gravity is not “coupled” to the lower object unless the upper object is otherwise maintained substantially in place. That is, for example, a book on a table is not coupled thereto, but a book glued to a table is coupled thereto.

As used herein, the phrase “removably coupled” or “temporarily coupled” means that one component is coupled with another component in an essentially temporary manner. That is, the two components are coupled in such a way that the joining or separation of the components is easy and would not damage the components. For example, two components secured to each other with a limited number of readily accessible fasteners, i.e., fasteners that are not difficult to access, are “removably coupled” whereas two components that are welded together or joined by difficult to access fasteners are not “removably coupled.” A “difficult to access fastener” is one that requires the removal of one or more other components prior to accessing the fastener wherein the “other component” is not an access device such as, but not limited to, a door.

As used herein, “operatively coupled” means that a number of elements or assemblies, each of which is movable between a first position and a second position, or a first configuration and a second configuration, are coupled so that as the first element moves from one position/configuration to the other, the second element moves between positions/configurations as well. It is noted that a first element may be “operatively coupled” to another without the opposite being true.

As used herein, the statement that two or more parts or components “engage” one another means that the elements exert a force or bias against one another either directly or through one or more intermediate elements or components. Further, as used herein with regard to moving parts, a moving part may “engage” another element during the motion from one position to another and/or may “engage” another element once in the described position. Thus, it is understood that the statements, “when element A moves to element A first position, element A engages element B,” and “when element A is in element A first position, element A engages element B” are equivalent statements and mean that element A either engages element B while moving to element A first position and/or element A either engages element B while in element A first position.

As used herein, “operatively engage” means “engage and move.” That is, “operatively engage” when used in relation to a first component that is structured to move a movable or rotatable second component means that the first component applies a force sufficient to cause the second component to move. For example, a screwdriver may be placed into contact with a screw. When no force is applied to the screwdriver, the screwdriver is merely “temporarily coupled” to the screw. If an axial force is applied to the screwdriver, the screwdriver is pressed against the screw and “engages” the screw. However, when a rotational force is applied to the screwdriver, the screwdriver “operatively engages” the screw and causes the screw to rotate. Further, with electronic components, “operatively engage” means that one component controls another component by a control signal or current.

As used herein, “correspond” indicates that two structural components are sized and shaped to be similar to each other and may be coupled with a minimum amount of friction. Thus, an opening which “corresponds” to a member is sized slightly larger than the member so that the member may pass through the opening with a minimum amount of friction. This definition is modified if the two components are to fit “snugly” together. In that situation, the difference between the size of the components is even smaller whereby the amount of friction increases. If the element defining the opening and/or the component inserted into the opening are made from a deformable or compressible material, the opening may even be slightly smaller than the component being inserted into the opening. With regard to surfaces, shapes, and lines, two, or more, “corresponding” surfaces, shapes, or lines have generally the same size, shape, and contours.

As used herein, the word “unitary” means a component that is created as a single piece or unit. That is, a component that includes pieces that are created separately and then coupled together as a unit is not a “unitary” component or body.

As used herein, the term “number” shall mean one or an integer greater than one (i.e., a plurality). That is, for example, the phrase “a number of elements” means one element or a plurality of elements. It is specifically noted that the term “a ‘number’ of [X]” includes a single [X].

As used herein, in the phrase “[x] moves between its first position and second position,” or, “[y] is structured to move [x] between its first position and second position,” “[x]” is the name of an element or assembly. Further, when [x] is an element or assembly that moves between a number of positions, the pronoun “its” means “[x],” i.e., the named element or assembly that precedes the pronoun “its.”

As used herein, a “radial side/surface” for a circular or cylindrical body is a side/surface that extends about, or encircles, the center thereof or a height line passing through the center thereof. As used herein, an “axial side/surface” for a circular or cylindrical body is a side that extends in a plane extending generally perpendicular to a height line passing through the center of the cylinder. That is, generally, for a cylindrical soup can, the “radial side/surface” is the generally circular sidewall and the “axial side(s)/surface(s)” are the top and bottom of the soup can. Further, as used herein, “radially extending” means extending in a radial direction or along a radial line. That is, for example, a “radially extending” line extends from the center of the circle or cylinder toward the radial side/surface. Further, as used herein, “axially extending” means extending in the axial direction or along an axial line. That is, for example, an “axially extending” line extends from the bottom of a cylinder toward the top of the cylinder and substantially parallel to a central longitudinal axis of the cylinder.

As employed herein, the terms “can” and “container” are used substantially interchangeably to refer to any known or suitable container, which is structured to contain a substance (e.g., without limitation, liquid; food; any other suitable substance), and expressly includes, but is not limited to, beverage cans, such as beer and beverage cans, as well as food cans.

As used herein, “about” in a phrase such as “disposed about [an element, point or axis]” or “extend about [an element, point or axis]” or “[X] degrees about an [an element, point or axis],” means encircle, extend around, or measured around. When used in reference to a measurement or in a similar manner, “about” means “approximately,” i.e., in an approximate range relevant to the measurement as would be understood by one of ordinary skill in the art.

As used herein, a “drive assembly” means elements that are operatively coupled to the rotating shafts extending back to front in a processing module. A “drive assembly” does not include the rotating shafts extending back to front in a processing module.

As used herein, a “lubrication system” means a system that applies a lubricant to the external surfaces of a linkage, e.g., shafts and gears, of a drive assembly.

As used herein, an “elongated” element inherently includes a longitudinal axis and/or longitudinal line extending in the direction of the elongation.

As used herein, “generally” means “in a general manner” relevant to the term being modified as would be understood by one of ordinary skill in the art.

As used herein, “substantially” means “for the most part” relevant to the term being modified as would be understood by one of ordinary skill in the art.

As used herein, “at” means on and/or near relevant to the term being modified as would be understood by one of ordinary skill in the art.

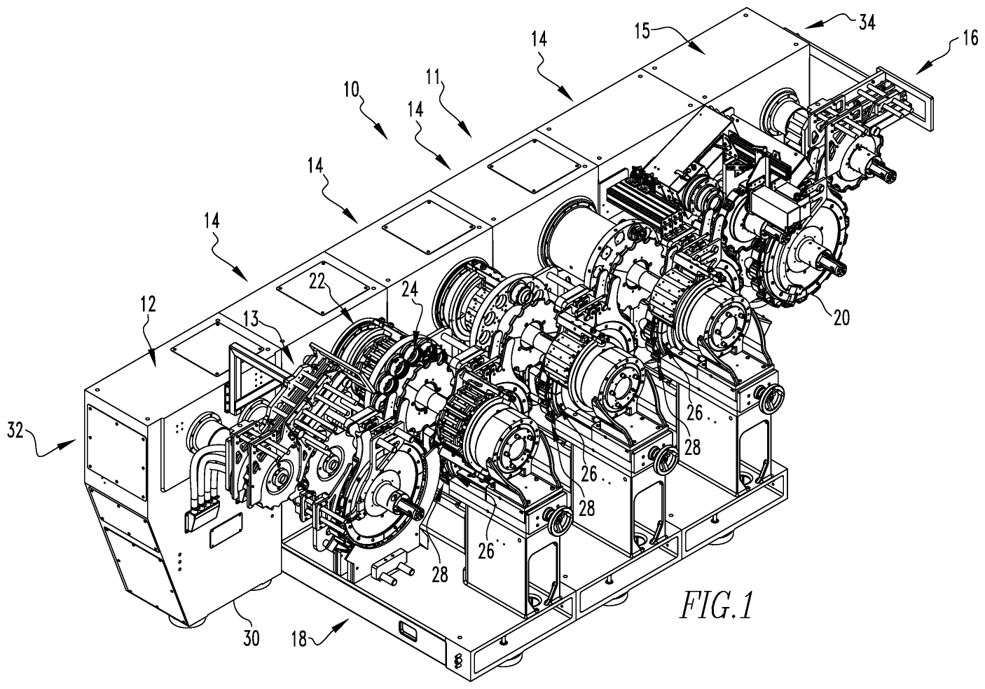

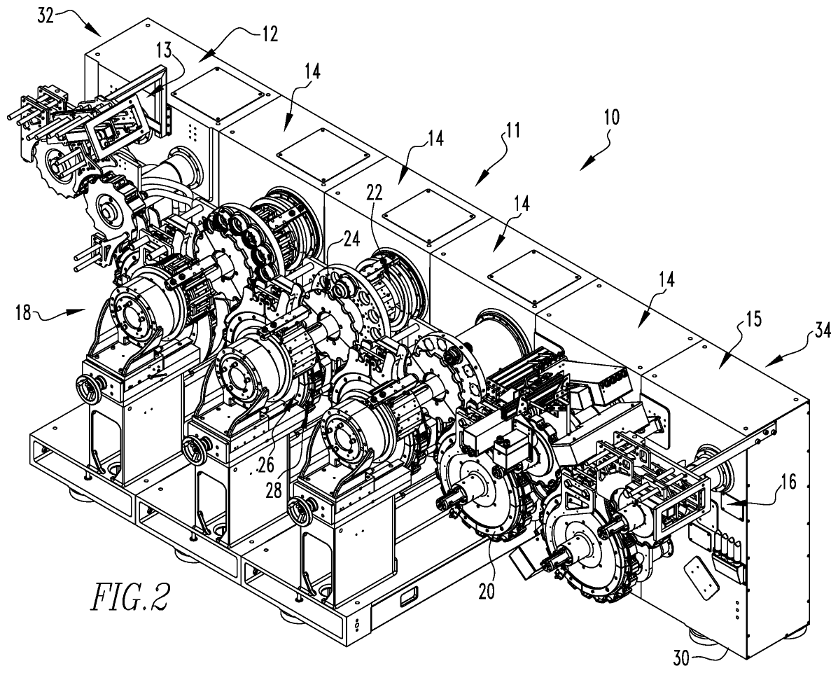

An example necker machine 10 for which a drive assembly in accordance with the concepts disclosed herein may be employed is illustrated in FIGS. 1-4. While a brief description of the general elements and operation of necker machine 10 is provided herein, a detailed description of a similar necker machine and the operation thereof is provided in U.S. patent application Ser. No. 16/407,292, filed May 9, 2019 (having a common inventor with this application), the contents of which are incorporated by reference herein. Some other examples of necker machines for which drive assemblies in accordance with the concepts disclosed herein may be employed are described in, for example, without limitation, U.S. Pat. Nos. 8,464,567, 8,601,843, 9,095,888, and 9,308,570, the contents of each being incorporated by reference herein.

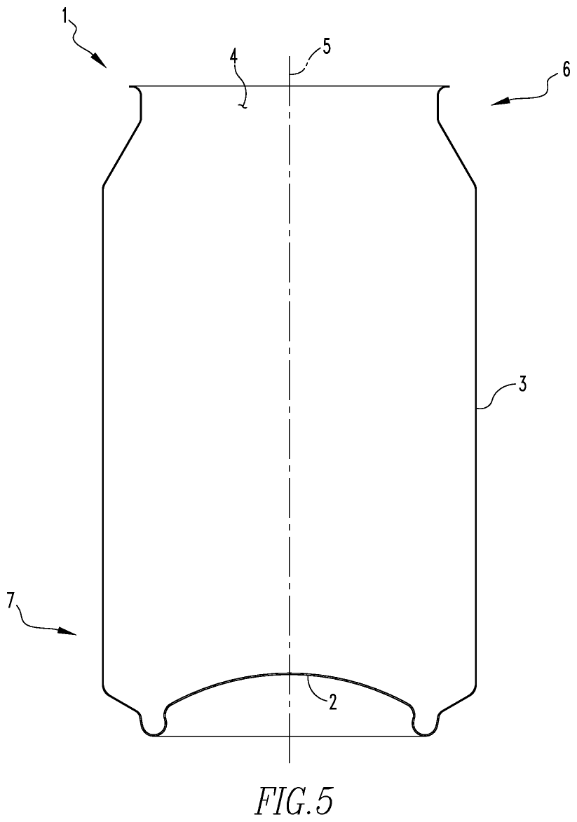

As previously discussed in the Background Information above, the necker machine 10 is structured to reduce the diameter of a portion of a can body 1, such as illustrated in FIG. 5. As used herein, to “neck” means to reduce the diameter/radius of a portion of a can body 1. That is, as shown in FIG. 5, a can body 1 includes a base 2 with an upwardly depending sidewall 3. The can body base 2 and can body sidewall 3 define a generally enclosed space 4. In the embodiment discussed below, the can body 1 is a generally circular and/or an elongated cylinder. It is understood that this is only one exemplary shape and that the can body 1 can have other shapes. The can body has a longitudinal axis 5. The can body sidewall 3 has a first end 6 and a second end 7. The can body base 2 is at the second end 7. The can body first end 6 is open. The can body first end 6 initially has substantially the same radius/diameter as the can body sidewall 3. Following forming operations in the necker machine 10, the radius/diameter of the can body first end 6 is smaller than the other portions of the radius/diameter at the can body sidewall 3.

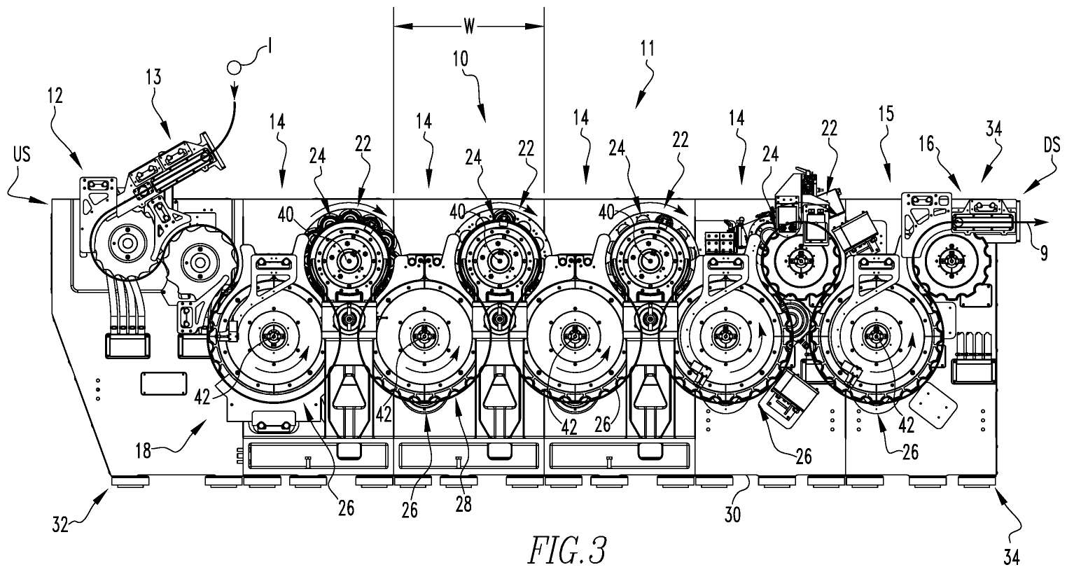

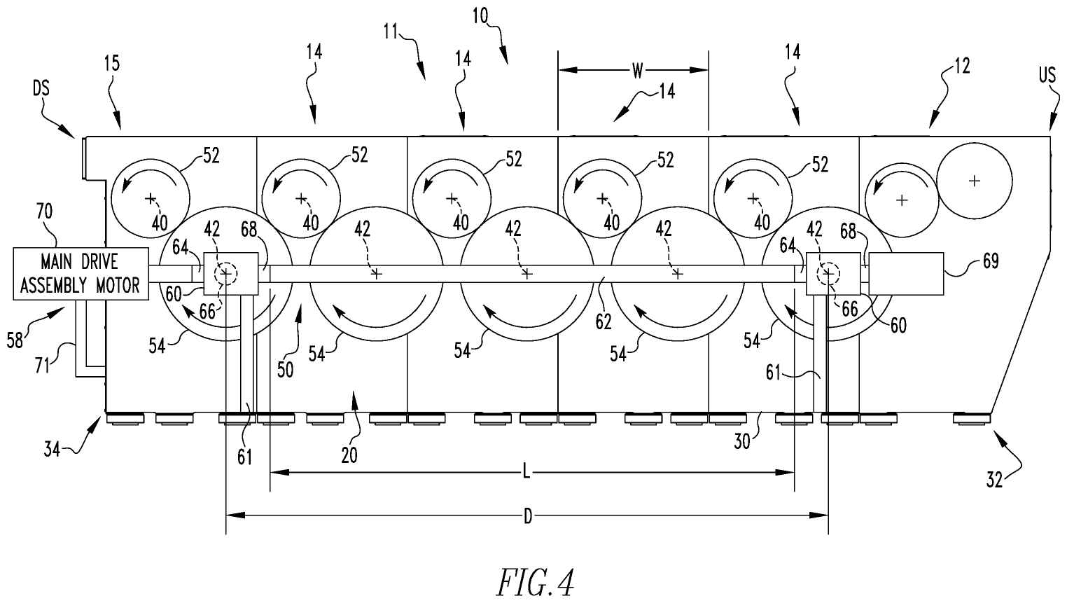

Referring to FIGS. 1-3, the necker machine 10 generally includes a plurality of modules (shown generally at 11) coupled together in a side by side arrangement. While the example necker machine 10 includes six of such modules 11, it is to be appreciated that the quantity of modules 11 included in a given necker machine is generally dependent on details of the can body being processed/formed and the final desired geometry thereof and as such the quantity of modules 11 may be varied without varying from the scope of the disclosed concept. The plurality of modules 11 includes an infeed module 12 positioned at a first end of the necker machine 10. The infeed module 12 includes an infeed assembly 13 for receiving can bodies 1 (e.g., see FIG. 3). The plurality of modules 11 also includes a plurality of forming/processing modules 14 extending side by side in a series arrangement from the infeed module 12. The plurality of modules 11 concludes with a discharge module 15 positioned at the opposite end of the necker machine from the infeed module 12 such that the plurality of processing modules 14 are bounded by the infeed module 12 and the discharge module 15. The discharge module 15 includes an exit assembly 16 for discharging necked cans from the necker machine 10. Hereinafter, the processing/forming modules 14 are identified by the term “processing modules 14” and refer to generic processing modules 14. Each processing module 14 has an overall width W (FIGS. 3 and 4) that is generally the same as all the other processing modules 14. Accordingly, it is to be appreciated that the length/space occupied by the necker machine 10 is generally determined by the quantity of processing modules 14 utilized therein.

As is known, the processing modules 14 are disposed adjacent to each other and in series with the infeed module 12 and discharge module 15 disposed at opposite ends of the series of processing modules. That is, the can bodies 1 being processed by the necker machine 10 each move from an upstream location through a series of processing modules 14 in the same sequence. Movement of the can bodies 1 through the necker machine 10 is carried out by a transfer assembly 18 driven by a drive assembly 20 (FIG. 4) that are both included as portions of the necker machine 10.

During processing, the can bodies 1 follow a path, hereinafter, the “work path 9” (FIG. 3). That is, the necker machine 10 defines the work path 9 wherein can bodies 1 move from an “upstream” US location to a “downstream” DS location, such as shown in FIG. 3. As used herein, “upstream” generally means closer to the infeed module 12/infeed assembly 13 and “downstream” means closer to the discharge module 15/exit assembly 16. With regard to elements that define the work path 9, each of those elements have an “upstream” end and a “downstream end” wherein the can bodies move from the “upstream” end to the “downstream end.” Thus, as used herein, the nature/identification of an element, assembly, sub-assembly, etc. as an “upstream” or “downstream” element or assembly, or, being in an “upstream” or “downstream” location, is inherent. Further, as used herein, the nature/identification of an element, assembly, sub-assembly, etc. as an “upstream” or “downstream” element or assembly, or, being in an “upstream” or “downstream” location, is a relative term.

As noted above, each processing module 14 has a similar width W (i.e., the distance between the upstream and downstream edges thereof), and the can body 1 is processed and/or formed (or partially formed) as the can body 1 moves generally across the width W. Generally, the processing/forming of the can body occurs in/at a rotatable turret 22 in each processing module 14. That is, the term “turret 22” identifies a generic turret. Each processing module 14 includes a rotatable starwheel 24 associated with the turret 22. Depending on the application, the starwheel 24 may be a “non-vacuum starwheel” (i.e., a starwheel that does not include, or is not associated with, a vacuum assembly, that is structured to apply a vacuum to the starwheel pockets) or alternatively a “vacuum starwheel” (i.e., a starwheel that does include, or is associated with, a vacuum assembly, that is structured to apply a vacuum to the starwheel pockets) without varying from the scope of the disclosed concept. Further, each processing module 14 typically includes one turret 22 and one starwheel 24.

The transfer assembly 18 is structured to move the can bodies 1 between adjacent processing modules 14 as well as from the infeed module 12 and to the discharge module 15. The transfer assembly 18 includes a plurality of rotatable starwheels 26, with each starwheel 26 being a part of a respective processing module 14, infeed module 12, or discharge module 15. Similar to starwheels 24, depending on the application starwheels 26 may be of a “vacuum” or “non-vacuum” type without varying from the scope of the disclosed concept.

It is noted that the plurality of processing modules 14 may be structured to neck different types of can bodies 1 and/or to neck can bodies in different configurations. Thus, the plurality of processing modules 14 are structured to be added and removed from the necker machine 10 depending upon the need for the particular application. To accomplish this, the necker machine 10 includes a frame assembly 30 to which the plurality of processing modules 14 are removably coupled. Alternatively, the frame assembly 30 includes elements incorporated into each of the plurality of processing modules 14 so that the plurality of processing modules 14 are structured to be temporarily coupled to each other. The frame assembly 30 has an upstream end 32 and a downstream end 34. Further, the frame assembly 30 includes elongated members, panel members (neither numbered), or a combination of both. As is known, panel members coupled to each other, or coupled to elongated members, form a housing. Accordingly, as used herein, a housing is also identified as a “frame assembly 30.”

When necker machine 10 is operated, the infeed assembly 13 feeds individual can bodies 1 into the transfer assembly 18 which moves each can body 1 sequentially through each of the processing modules 14 from the most upstream processing module 14 to the most downstream processing module 14. More particularly, each can body 1 moves from a starwheel 26, to a starwheel 24, to a turret 22 where a forming operation occurs, back to the aforementioned starwheel 24, and on to the next downstream starwheel 26. Generally, each processing module 14 is structured to partially form the can body 1 so as to gradually reduce the cross-sectional area of the can body first end 6 (FIG. 5) as the can body 1 moves through the processing modules 14. The processing modules 14 include some elements that are unique to a single particular processing module 14, such as, but not limited to, a specific die. Other elements, e.g., the turret 22 and starwheels 24, 26 of the processing modules 14 are common to all, or most, of the processing modules 14. Such process continues until the can body 1 has passed through all of the processing modules 14 along the work path 9 and then exits the necker machine 10 via the exit assembly 16.

Referring to FIG. 3, in order to move the can body 1 through the example necker machine 10, each of the turrets 22 and starwheels 24 are rotated in a clockwise direction at a first rotational speed by respective processing or primary drive shafts 40 while each of the starwheels 26 are rotated in a counter-clockwise direction at a second rotational speed by respective transfer or secondary drive shafts 42. Such rotation of each of the primary and secondary drive shafts 40, 42 of each processing module 14 is provided by the drive assembly 20 schematically illustrated in FIG. 4 that addresses shortcomings of drive assemblies utilizing a gear train (such as previously discussed herein) and that may be readily retrofit to other necker machines that employ a gear train.

Referring to FIG. 4, drive assembly 20 includes a gear train 50 formed from a plurality of primary gears 52 and a plurality of secondary gears 54. Each primary gear 52 (shown schematically in FIG. 4 without teeth) is mounted proximate an end of each primary drive shaft 40 opposite the turret 22 coupled to the aforementioned primary drive shaft 40, and each secondary gear 54 (also shown schematically in FIG. 4 without teeth) is mounted proximate an end of each secondary drive shaft 42 opposite the vacuum starwheel 26 coupled to the aforementioned secondary driveshaft. Each gear 52, 54 may be made of any suitable material, and in one example embodiment are both made of steel. In another example embodiment, alternating gears formed from steel and polymer (e.g., nylon) are employed so as to not require lubrication. Other non-metal (fiber/composite) gear materials may also be used in conjunction with a steel or metal gear to again avoid a lubrication requirement. Each gear 52, 54 is sized so as to rotate at the desired relative speed for the particular application. Primary gears 52 and secondary gears 54 are meshed together such that: each primary gear 52 is meshed between, and with, only two secondary gears 54, and likewise each secondary gear 54 is meshed between, and with, only two primary gears 52. Accordingly, in the gear train 50 all of the primary gears 52 rotate in the same direction (e.g., counter-clockwise in FIG. 4), while all of the secondary gears 54 rotate in the opposite direction from the primary gears 52 (e.g., clock-wise in FIG. 4). It is to thus be appreciated that the gear train 50 thus interconnects the number of drive shafts (e.g., primary drive shaft 40 and secondary drive shaft 42) of each processing module 14 with the number of drive shafts of the other processing modules 14 of necker machine 10 as well as to other driven components of the infeed and discharge modules 12 and 15.

Continuing to refer to FIG. 4, drive assembly 20 further includes a distributed drive assembly 58 that drives gear train 50. Unlike arrangements such as discussed previously herein wherein a gear train was driven at a single end, the distributed drive assembly 58 drives gear train 50 at multiple locations, thus better distributing the loading on the gear train 50 than arrangements such as previously discussed in the Background Information section herein. To accomplish such distribution, distributed drive assembly 58 includes a plurality of drive sub-modules 60 (two are included in the example drive assembly 20 shown in FIG. 4) coupled to the frame 30 via a sub-frame 61 and a number of extension shafts 62 (one is included in the example drive assembly 20 shown in FIG. 4) positioned between drive sub-modules 60. Each drive sub-module 60 includes: an input shaft 64, a first output shaft 66 that is operatively coupled to the input shaft 64, and a second output shaft 68 that is also operatively coupled to the input shaft 64. Such operative coupling provides for both the first output shaft 66 and the second output shaft 68 to rotate upon rotation of the input shaft 64. In the example shown in FIG. 4, each first output shaft 66 is operatively coupled to the associated input shaft 64 via a right-angle gearbox (not numbered), while each second output shaft 68 is operatively coupled (via any suitable arrangement) to the associated input shaft 64 in a manner such that the second output shaft 68 and the input shaft 64 are axially aligned (i.e., rotate about a common axis, not numbered). In the example shown in FIG. 4, for the most downstream drive sub-module 60 (i.e., the left-most one shown in FIG. 4): the input shaft 64 is operatively coupled to, and driven by, a lone main drive assembly motor 70 that is coupled to frame 30 via another sub-frame 71, and the first output shaft 66 is operatively or otherwise directly or indirectly coupled to (e.g., via secondary gear 54 or any other suitable arrangement), and drives, the secondary drive shaft 42 of discharge module 15. Meanwhile, for the most upstream drive sub-module 60 (i.e., the right-most one shown in FIG. 4): the input shaft 64 is operatively coupled (via the extension shaft 62) to, and driven by, the second output shaft 68 of the aforementioned downstream drive sub-module 60, and the first output shaft 66 is operatively or otherwise directly or indirectly coupled to (e.g., via any suitable arrangement), and drives, the secondary drive shaft 42 of a processing module 14 that is separated from the discharge module 15 by at least one other processing module 14 (in the example shown in FIG. 4 such separation is three processing modules 14). The aforementioned separation is accomplished by the use of the extension shaft 62, which has a length L that generally results in the first output shafts 66 of the two drive sub-modules 60 being separated a distance D (as measured centerline to centerline). The extension shaft 62 may be formed from steel or other suitable material or materials. For example, an extension shaft 62 made from carbon fiber can be employed to increase the critical shaft speed and thus the allowable running speed of the necker machine 10. Accordingly, it is to be appreciated that main drive assembly motor 70 drives gear train 50 via the distributed drive assembly 58 in multiple locations (instead of one), thus better distributing the loading on gear train 50 than previous arrangements, and thus reducing the thickness of the gears needed in the gear train 50 as compared to previous arrangements. Although shown in the example embodiment illustrated in FIG. 4 as being coupled to the discharge module 15 and the most upstream processing module 14, it is to be appreciated that the distributed drive assembly 58 may be coupled to other modules 11 without varying from the scope of the disclosed concepts. It is also to be appreciated that although shown coupled to, and driving, the secondary drive shafts 42 associated with the gear train 50, that the distributed drive assembly could instead be coupled to, and drive, other components in the gear train 50 (e.g., primary drive shafts 40, a combination of primary and secondary drive shafts 40 and 42, etc.) without varying from the scope of the disclosed concepts.

Binding in the gear train 50 resulting from the multiple drive points may be avoided in a number of ways. In one example approach, during setup (timing) of the machine, the left-most drive sub-module 60 shown in FIG. 4 is operatively coupled to module 15. Then the main drive assembly motor 70 is allowed to drive the machine 10 very slowly until all of the backlash is taken out of the gear train 50. Once the backlash is taken up through the gear train 50 the right-most drive sub-module 60 shown in FIG. 4 is operatively coupled to the processing module 14.

As shown in FIG. 4, the second output shaft 68 of the most upstream drive sub-module 60 (i.e., the right-most drive sub-module 60 shown in FIG. 4) may be utilized by a suitable winding arrangement 69 for winding the necker machine 10. Such arrangement 69 may be: a crank to provide for hand-winding, an electric motor to provide for automated winding, or any other suitable arrangement without varying from the scope of the disclosed concept.

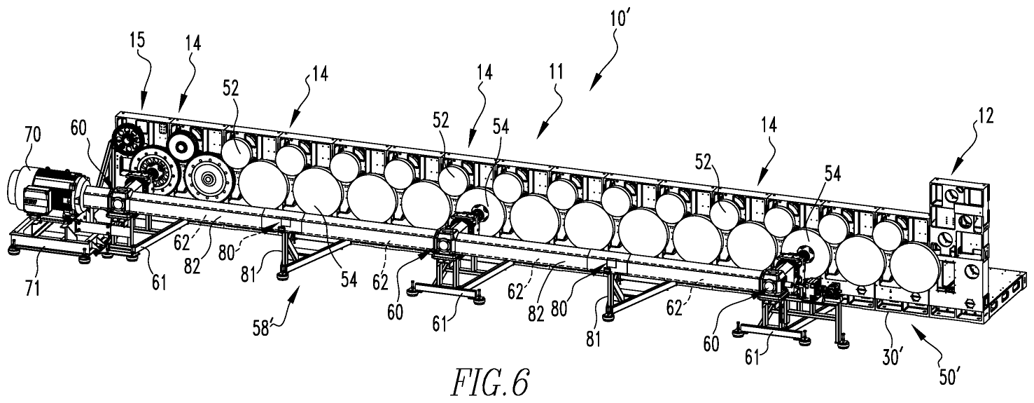

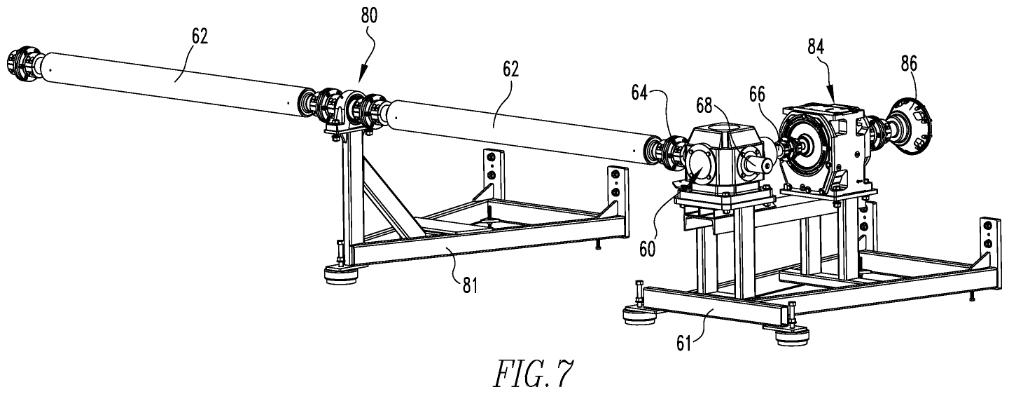

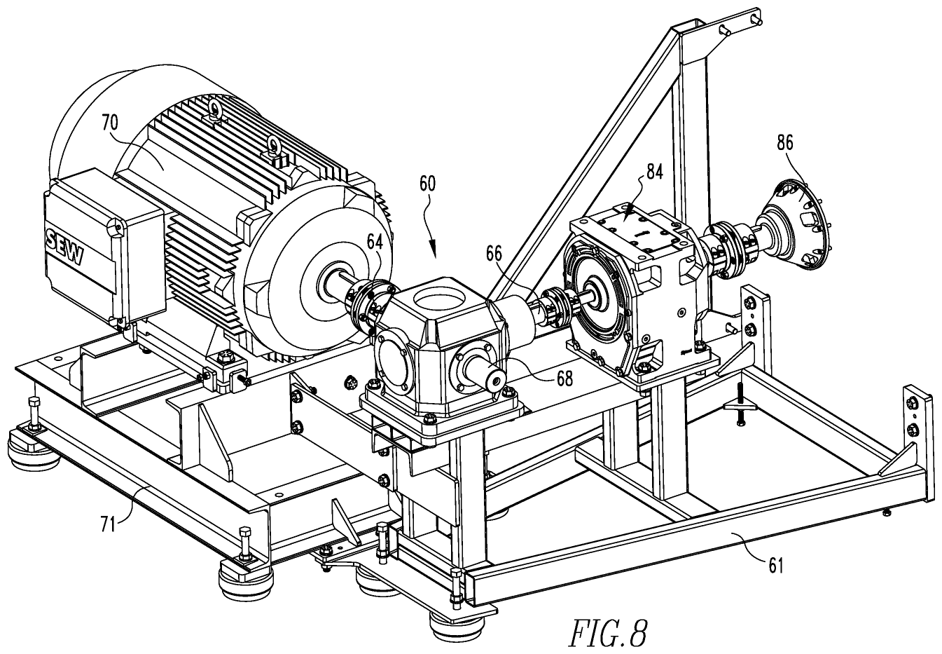

While the example distributed drive assembly 58 shown in FIG. 4 utilizes only two drive sub-modules 60 connected via a single extension shaft 62, it is to be appreciated that the quantity of one or both of the drive sub-modules 60 and/or extensions shafts 62 utilized in a drive assembly 50 of a necker machine may be varied as needed dependent on the quantity of processing modules 14 utilized in the particular necker machine and/or other details/requirements of the particular arrangement. For example, FIGS. 6-8 show, partially schematically, an example necker machine 10′ (and detailed views of portions thereof) that includes fourteen processing modules 14 (only some of which are numbered) driven by a drive assembly 20′ having a distributed drive assembly 58′ that includes/utilizes three drive sub-modules 60, with each drive sub-module coupled by two extension shafts 62 (shown schematically in hidden line in FIG. 6) that are coupled together in a series arrangement between the drive sub-modules 60 by a coupling 80. The coupling 80 between the two extension shafts 60 is supported by a suitable sub-frame 81 that is coupled to frame 30′ of the necker machine 10′. In the view shown in FIG. 6, the extension shafts 62 and couplings 80 are covered by removable safety shielding 82 provided in a number of sections that are selectively coupled (e.g., via any suitable arrangement) to one or more of sub-frames 61 and/or 81. As best shown in FIGS. 7 and 8, in such example embodiment each drive sub-module 60 is coupled to a corresponding secondary drive shaft 42 via a speed reducing gearbox 84 and a drive hub 86 which is coupled to the secondary gear 52 (FIG. 6) of the secondary drive shaft 42. However, as previously discussed, it is to be appreciated that such particular arrangement is provided for exemplary purposes only and that such coupling of the between the distributed drive assembly 58′ and the gear train 50′ may be accomplished via any other suitable arrangement without varying from the scope of the disclosed concepts.

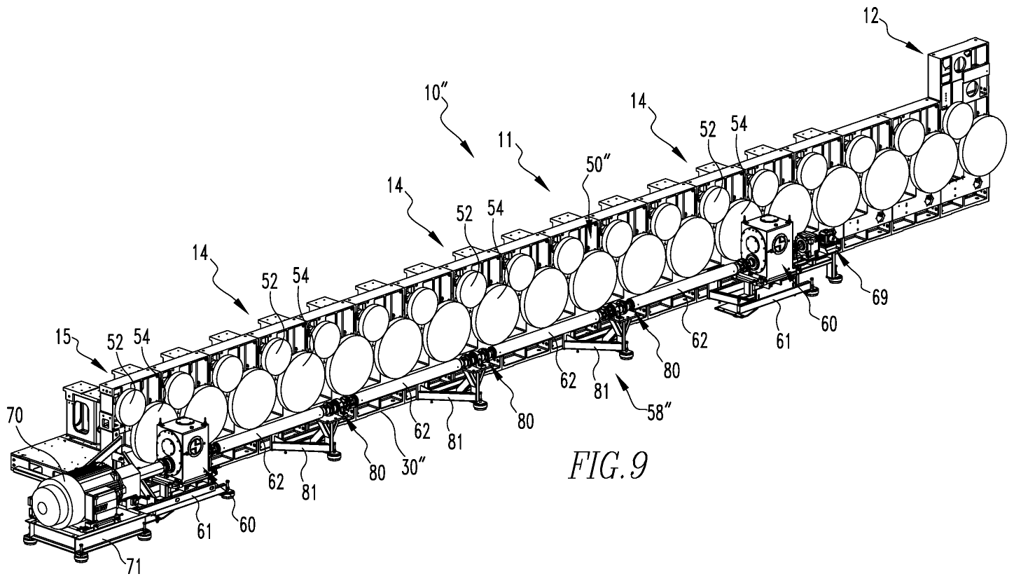

As another example, FIG. 9 shows an example necker machine 10″ that includes sixteen processing modules 14 (only some of which are numbered) driven by a drive assembly including a distributed drive assembly 58″ that includes/utilizes two drive sub-modules 60, with each drive sub-module 60 coupled by four extension shafts 62. More particularly, the four extension shafts 62 are coupled together in a series arrangement between the drive sub-modules 60 by three couplings 80, with each coupling 80 coupling two adjacent extension shafts 62. Each coupling 80 between two adjacent extension shafts 60 is supported by a suitable sub-frame 81 that is coupled to frame 30″ of the necker machine 10″. In the example shown in FIG. 9, the drive sub-modules 60 are coupled to the discharge module 15 and the twelfth upstream processing module, however, once again it is to be appreciated that the drive sub-modules 60 may be coupled to other modules 11 without varying from the scope of the disclosed concept.

From the foregoing example embodiments it is thus to be appreciated that embodiments of the concepts disclosed herein provide arrangements for driving necker machines that improve upon conventional arrangements by distributing the driving forces along the gear train while utilizing only a single drive motor. By better distributing the forces along the gear train, gears of lesser strength (e.g., thinner and/or formed from alternate materials (e.g., polymer, composite, etc.) may be employed in the gear train thus reducing costs of the gear train while improving reliability.

While specific embodiments of the disclosed concepts have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concepts which are to be given the full breadth of the claims appended and any and all equivalents thereof.

What is claimed is:

1. A distributed drive assembly for a necker machine having a frame assembly and a plurality of modules, each module having a number of drive shafts, the number of drive shafts of each module interconnected via a gear train with the number of drive shafts of the other modules of the plurality of processing modules, said distributed drive assembly comprising:
a plurality of drive sub-modules, each drive sub-module comprising:
an input shaft;
a first output shaft operatively coupled to the input shaft; and
a second output shaft operatively coupled to the input shaft;
wherein for a first drive sub-module of the plurality of drive sub-modules:
the input shaft is structured to be operatively coupled to, and driven by, a main drive assembly motor, and
the first output shaft is structured to be operatively coupled to, and drive, an associated first drive shaft of the number of drive shafts of a first module of the plurality of modules, and
wherein for a second drive sub-module of the plurality of drive sub-modules:
the input shaft is operatively coupled to, and driven by, the second output shaft of the first drive sub-module, and
the first output shaft is structured to be operatively coupled to, and drive, an associated first drive shaft of the number of drive shafts of a second module of the plurality of modules that is separated from the first module by at least one other module.

2. The distributed drive assembly of claim 1, further comprising an extension shaft, wherein the input shaft of the second drive sub-module is operatively coupled to the second output shaft of the first drive sub-module by the extension shaft.

3. The distributed drive assembly of claim 2, wherein the extension shaft is sized and configured to space the first output shaft of the second drive sub-module a distance from the first output shaft of the first drive sub-module, and wherein the distance is greater than an overall width of one module of the plurality of processing modules.

4. The distributed drive assembly of claim 1, wherein the plurality of drive modules comprises at least three drive sub-modules, and
wherein for a third drive sub-module of the plurality of drive sub-modules:
the input shaft is operatively coupled to, and driven by, the second output shaft of the second drive sub-module, and
the first output shaft is structured to be operatively coupled to, and drive, one drive shaft of the number of drive shafts of a third module of the number of modules.

5. The distributed drive assembly of claim 1, wherein for each drive sub-module, the first output shaft is operatively coupled to the input shaft via a right-angle gearbox.

6. The distributed drive assembly of claim 1, wherein for each drive sub-module, the second output shaft is axially aligned with the input shaft.

7. The distributed drive assembly of claim 1, further comprising the main drive assembly motor coupled to the input shaft of the first drive sub-module of the plurality of drive sub-modules.

8. The distributed drive assembly of claim 1, further comprising at least two extension shafts, wherein the input shaft of the second drive sub-module is operatively coupled to the second output shaft of the first drive sub-module by the at least two extension shafts connected together in series.

9. The distributed drive assembly of claim 1, further comprising a winding arrangement operatively coupled to the second output shaft of the second drive sub-module.

10. A necker machine comprising:
a frame assembly;
a plurality of modules coupled to the frame assembly, each module having a number of drive shafts, and
a drive assembly comprising:
a gear train comprising a plurality of gears, each gear coupled to a respective drive shaft of the number of drive shafts of the plurality of modules and interconnecting the number of drive shafts of each module with the number of drive shafts of the other modules of the plurality of modules; and
a distributed drive assembly comprising a plurality of drive sub-modules, each drive sub-module comprising:
an input shaft;
a first output shaft operatively coupled to the input shaft; and
a second output shaft operatively coupled to the input shaft;
wherein for a first drive sub-module of the plurality of drive sub-modules:
the input shaft is structured to be operatively coupled to, and driven by, a main drive assembly motor, and
the first output shaft is operatively coupled to, for driving, an associated first drive shaft of the number of drive shafts of a first module of the plurality of modules, and
wherein for a second drive sub-module of the plurality of drive sub-modules:
the input shaft is operatively coupled to, and driven by, the second output shaft of the first drive sub-module, and
the first output shaft is operatively coupled to, for driving, an associated first drive shaft of the number of drive shafts of a second module of the plurality of modules that is separated from the first module by at least one other module.

11. The necker machine of claim 10, further comprising the main drive assembly motor coupled to the input shaft of the first drive sub-module of the plurality of drive sub-modules.

12. The necker machine of claim 10, wherein:
the first output shaft of the first drive sub-module is coupled to the associated first drive shaft of the number of drive shafts of the first module via a speed reducing gearbox and a drive hub, and
the first output shaft of the second drive sub-module is coupled to the associated first drive shaft of the number of drive shafts of the second module via another speed reducing gearbox and another drive hub.

13. The necker machine of claim 10, further comprising an extension shaft, wherein the input shaft of the second drive sub-module is operatively coupled to the second output shaft of the first drive sub-module by the extension shaft.

14. The necker machine of claim 13, wherein the extension shaft is sized and configured to space the first output shaft of the second drive sub-module a distance from the first output shaft of the first drive sub-module, and wherein the distance is greater than an overall width of one module of the plurality of processing modules.

15. The necker machine of claim 10, wherein the plurality of drive modules comprises at least three drive sub-modules, and
wherein for a third drive sub-module of the plurality of drive sub-modules:
the input shaft is operatively coupled to, and driven by, the second output shaft of the second drive sub-module, and
the first output shaft is operatively coupled to, and drives, one drive shaft of the number of drive shafts of a third module of the number of modules.

16. The necker machine of claim 10, wherein for each drive sub-module, the first output shaft is operatively coupled to the input shaft via a right-angle gearbox.

17. The necker machine of claim 10, wherein for each drive sub-module, the second output shaft is axially aligned with the input shaft.

18. The necker machine of claim 10, further comprising at least two extension shafts, wherein the input shaft of the second drive sub-module is operatively coupled to the second output shaft of the first drive sub-module by the at least two extension shafts connected together in series.

19. The necker machine of claim 10, further comprising a winding arrangement operatively coupled to the second output shaft of the second drive sub-module.
